(19) United States
(12) Patent Application Publication
(10) Pub. No.: US 2014/0088766 A1
(43) Pub. Date: Mar. 27, 2014

(54) HEALTH MANAGEMENT HAVING SYSTEM LEVEL DIAGNOSTIC FEEDBACK AND INFORMATION FUSION

(71) Applicant: UNITED TECHNOLOGIES CORPORATION, Hartford, CT (US)

(72) Inventors: Liang Tang, Glastonbury, CT (US); Allan J. Volponi, West Simsbury, CT (US)

(73) Assignee: United Technologies Corporation, Hartford, CT (US)

(21) Appl. No.: 13/624,039

(22) Filed: Sep. 21, 2012

(51) Int. Cl. G05B 15/00

(52) U.S. Cl. 700/275

(57) ABSTRACT

A method of fusing information within a turbomachine health management system according to an exemplary aspect of the present disclosure includes, among other things, sending information collected within a first subsystem from the first subsystem to a system level reasoner, and adjusting a different, second subsystem based on the information from the first subsystem.

### BACKGROUND

This disclosure relative generally to turbomachine health and, more particularly, to a health management system that uses system-level diagnostic feedback to improve the performance of subsystem diagnosis and downstream Prognostics and Health Management systems consuming the improved diagnostic information, which produces improved overall engine system health assessment.

Turbomachines, such as gas turbine engines, typically include a fan section, a compression section, a combustion section, and a turbine section. Turbomachines may employ a geared architecture connecting portions of the compression section to the fan section.

A turbomachine may have an associated health management system. Information gathered by the health management systems may be used as diagnostic and prognostic information. Current health management systems have a hierarchical structure. These health management systems include several subsystems that may utilize sensors, for example, to collect information directly from the turbomachine. Information from the subsystems is sent upwards in the hierarchy and aggregated at system level. Diagnostic information exchange among subsystems can be utilized but is often error-prone due to lack of confidence and accuracy in individual subsystem diagnosis using local, incomplete information, as well as improper assumptions on extraneous variables when a fault occurs.

### SUMMARY

A method of fusing information within a turbomachine health management system according to an exemplary aspect of the present disclosure includes, among other things, sending information collected within a first subsystem from the first subsystem to a system level reasoner, and adjusting a different, second subsystem based on the information from the first subsystem.

In a further non-limiting embodiment of either of the foregoing methods of communicating information within a turbomachine health management system, the adjusting comprises changing how the second subsystem collects information.

In a further non-limiting embodiment of any of the foregoing methods of communicating information within a turbomachine health management system, the method includes substituting information sent from the second subsystem to the system level reasoner with information from the first subsystem.

In a further non-limiting embodiment of any of the foregoing methods of communicating information within a turbomachine health management system, the method recognizes a sensor failure within the second subsystem utilizing information from the first subsystem.

In a further non-limiting embodiment of any of the foregoing methods of communicating information within a turbomachine health management system, the adjusting is based further on information sent from the second subsystem to the system level reasoner.

Another method of communicating information within a turbomachine health management system according to an exemplary aspect of the present disclosure includes, among other things, collecting information from at least one first subsystem at a system level, and providing diagnostic feedback to at least one second subsystem, the diagnostic feedback adjusted in response to information from at least one subsystem, the at least one first subsystem different than the at least one second subsystem.

In a further non-limiting embodiment of the foregoing method of communicating information within a turbomachine health management system, the first subsystem and the second subsystem collect information from different groups of components.

In a further non-limiting embodiment of the foregoing method of communicating information within a turbomachine health management system, the method includes collecting information at the system level using a system-level reasoner.

In a further non-limiting embodiment of either of the foregoing methods of communicating information within a turbomachine health management system, the method includes collects information from the at least one second subsystem at the system level.

In a further non-limiting embodiment of any of the foregoing methods of communicating information within a turbomachine health management system, the method uses the diagnostic feedback to improve the diagnostic accuracy of the at least one second subsystem.

In a further non-limiting embodiment of any of the foregoing methods of communicating information within a turbomachine health management system, the method adjusts how the at least second subsystem collects information based on the diagnostic feedback.

In a further non-limiting embodiment of any of the foregoing methods of communicating information within a turbomachine health management system, the method replaces information from the at least one second subsystem with information from the at least one first subsystem based on the diagnostic feedback.

In a further non-limiting embodiment of any of the foregoing methods of communicating information within a turbomachine health management system, the method recognizes a sensor failure within the at least one second subsystem using the information from the at least one first subsystem.

In a further non-limiting embodiment of any of the foregoing methods of communicating information within a turbomachine health management system, the at least one first subsystem and the at least one second subsystem collect at least some information from a turbomachine using a common sensor.

A turbomachine health management system according to an exemplary aspect of the present disclosure includes, among other things, a first subsystem module configured to collect information from a first group of sensors within a turbomachine, a second subsystem module configured to collect information from a second group of sensors within the turbomachine, and a system module configured to adjust the first subsystem module based at least in part on information from the second subsystem module.

In a further non-limiting embodiment of the foregoing turbomachine health management system, the first subsystem module may be a blade or vane health module.

In a further non-limiting embodiment of either of the foregoing turbomachine health management system, the system module may be configured to adjust information received from the first subsystem based on information from the second subsystem.

In a further non-limiting embodiment of any of the foregoing turbomachine health management systems, the system may include at least one sensor that communicates information to the first subsystem module.

In a further non-limiting embodiment of any of the foregoing turbomachine health management systems, the system may include at least one sensor that communicates information to the first and the second subsystem modules.

### DESCRIPTION OF THE FIGURES

The various features and advantages of the disclosed examples will become apparent to those skilled in the art from the detailed description. The figures that accompany the detailed description can be briefly described as follows:

FIG. 1 shows an example turbomachine.

FIG. 2 shows a highly schematic view of an example health management system for use with the turbomachine of FIG. 1.

FIG. 3 shows a detailed schematic view of an example of the health management system of FIG. 2.

FIG. 4 shows a detailed schematic view of an example of the fusion of gas path performance monitoring, blade health monitoring and vibration monitoring and diagnostic feedback from system level reasoner to each subsystems.

### DETAILED DESCRIPTION

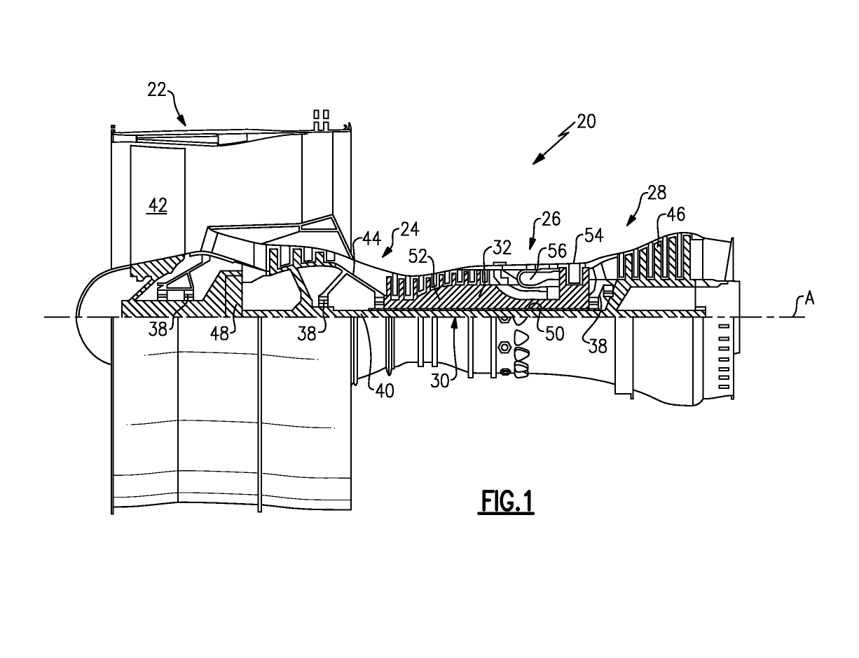

FIG. 1 schematically illustrates an example turbomachine, which is a gas turbine engine 20 in this example. The gas turbine engine 20 is a two-spool turbofan gas turbine engine that generally includes a fan section 22, a compression section 24, a combustion section 26, and a turbine section 28.

Although depicted as a two-spool turbofan gas turbine engine in the disclosed non-limiting embodiment, it should be understood that the concepts described herein are not limited to use with turbofans. That is, the teachings may be applied to other types of turbomachines and turbine engines including three-spool architectures. Further, the concepts described herein could be used in environments other than a turbomachine environment and in applications other than aerospace applications.

In the example engine 20, flow moves from the fan section 22 to a bypass flowpath. Flow from the bypass flowpath generates forward thrust. The compression section 24 drives air along a core flowpath. Compressed air from the compression section 24 communicates through the combustion section 26. The products of combustion expand through the turbine section 28.

The example engine 20 generally includes a low-speed spool 30 and a high-speed spool 32 mounted for rotation about an engine central axis A. The low-speed spool 30 and the high-speed spool 32 are rotatably supported by several bearing systems 38. It should be understood that various bearing systems 38 at various locations may alternatively, or additionally, be provided.

The low-speed spool 30 generally includes a shaft 40 that interconnects a fan 42, a low-pressure compressor 44, and a low-pressure turbine 46. The shaft 40 is connected to the fan 42 through a geared architecture 48 to drive the fan 42 at a lower speed than the low-speed spool 30.

The high-speed spool 32 includes a shaft 50 that interconnects a high-pressure compressor 52 and high-pressure turbine 54.

The shaft 40 and the shaft 50 are concentric and rotate via bearing systems 38 about the engine central longitudinal axis A, which is collinear with the longitudinal axes of the shaft 40 and the shaft 50.

The combustion section 26 includes a circumferentially distributed array of combustors 56 generally arranged axially between the high-pressure compressor 52 and the high-pressure turbine 54.

In some non-limiting examples, the engine 20 is a high-bypass geared aircraft engine. In a further example, the engine 20 bypass ratio is greater than about six (6 to 1).

The geared architecture 48 of the example engine 20 includes an epicyclic gear train, such as a planetary gear system or other gear system. The example epicyclic gear train has a gear reduction ratio of greater than about 2.3 (2.3 to 1).

The low-pressure turbine 46 pressure ratio is pressure measured prior to inlet of low-pressure turbine 46 as related to the pressure at the outlet of the low-pressure turbine 46 prior to an exhaust nozzle of the engine 20. In one non-limiting embodiment, the bypass ratio of the engine 20 is greater than about ten (10 to 1), the fan diameter is significantly larger than that of the low pressure compressor 44, and the low-pressure turbine 46 has a pressure ratio that is greater than about 5 (5 to 1). The geared architecture 48 of this embodiment is an epicyclic gear train with a gear reduction ratio of greater than about 2.5 (2.5 to 1). It should be understood, however, that the above parameters are only exemplary of one embodiment of a geared architecture engine and that the present disclosure is applicable to other gas turbine engines including direct drive turbofans.

In this embodiment of the example engine 20, a significant amount of thrust is provided by the bypass flow B due to the high bypass ratio. The fan section 22 of the engine 20 is designed for a particular flight condition—typically cruise at about 0.8 Mach and about 35,000 feet. This flight condition, with the engine 20 at its best fuel consumption, is also known as “Bucket Cruise” Thrust Specific Fuel Consumption (TSFC). TSFC is an industry standard parameter of fuel consumption per unit of thrust.

Fan Pressure Ratio is the pressure ratio across a blade of the fan section 22 without the use of a Fan Exit Guide Vane system. The low Fan Pressure Ratio according to one non-limiting embodiment of the example engine 20 is less than 1.45 (1.45 to 1).

Low Corrected Fan Tip Speed is the actual fan tip speed divided by an industry standard temperature correction of Temperature divided by 518.7 ̂ 0.5. That is, [(Tram ° R)/(518.7° R)]^{0.5}. The Temperature represents the ambient temperature in degrees Rankine. The Low Corrected Fan Tip Speed according to one non-limiting embodiment of the example engine 20 is less than about 1150 fps (351 m/s).

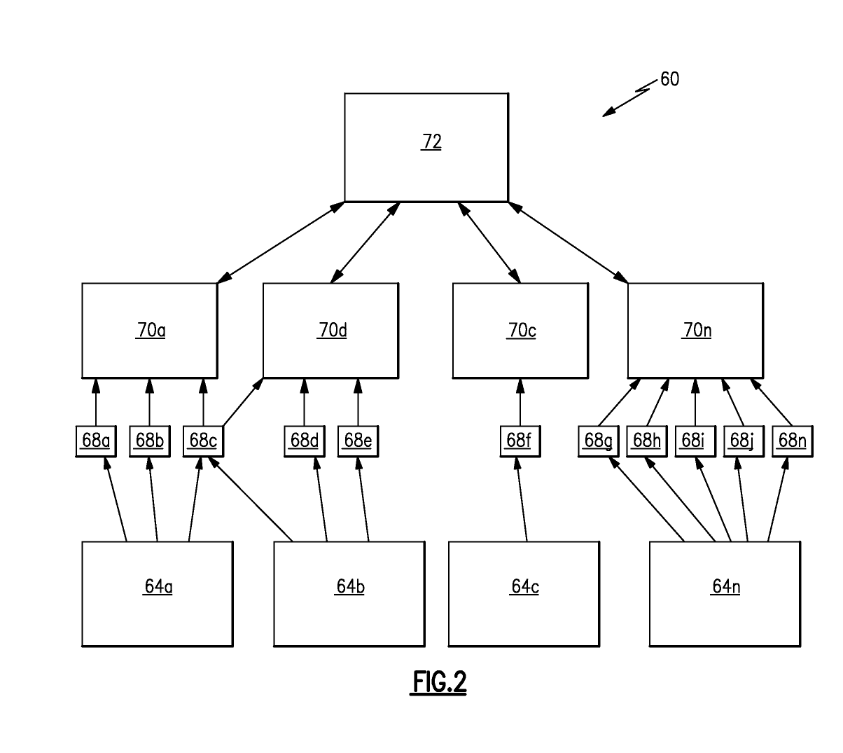

Referring to FIG. 2 with continuing reference to FIG. 1, an example health management system 60 for the engine 20 includes several groups of components 64a, 64b, . . . 64n. Sensors 68a, 68b, . . . 68n collect information from one or more of the groups of components 64a-64n. Subsystem diagnostic modules 70a-70n receive the collected information. The modules 70a-70n may diagnose performance, for example, of one or more of the groups of components 64a-64n based on the information form the sensors 68a-68n. For example, vibration, temperature and spool speed of the group of components 64a may be measured by the sensors 68a-68c. The module 70a may be tasked with communicating an alert in response to identifying extreme vibrations.

The module 70b may collect information from different sensors 68d-68e, and apply a correction factor to the collected information, etc. A system level reasoner 72 is in two-way communication with the modules 70a-70n. The qualitative reasoning performed in system level reasoner 72 fuses the diagnostic information from modules 70a-70n to produced improved engine health diagnosis with higher confidence and accuracy. The system level reasoner 72 is configured to provide feedback to each of the modules 70a-70n. The feedback may be based, at least in part, on information from other modules 70a-70n. Each of the modules 70a-70n thus possesses a global awareness of the overall system 60, which contributes to improved performance of each subsystem.

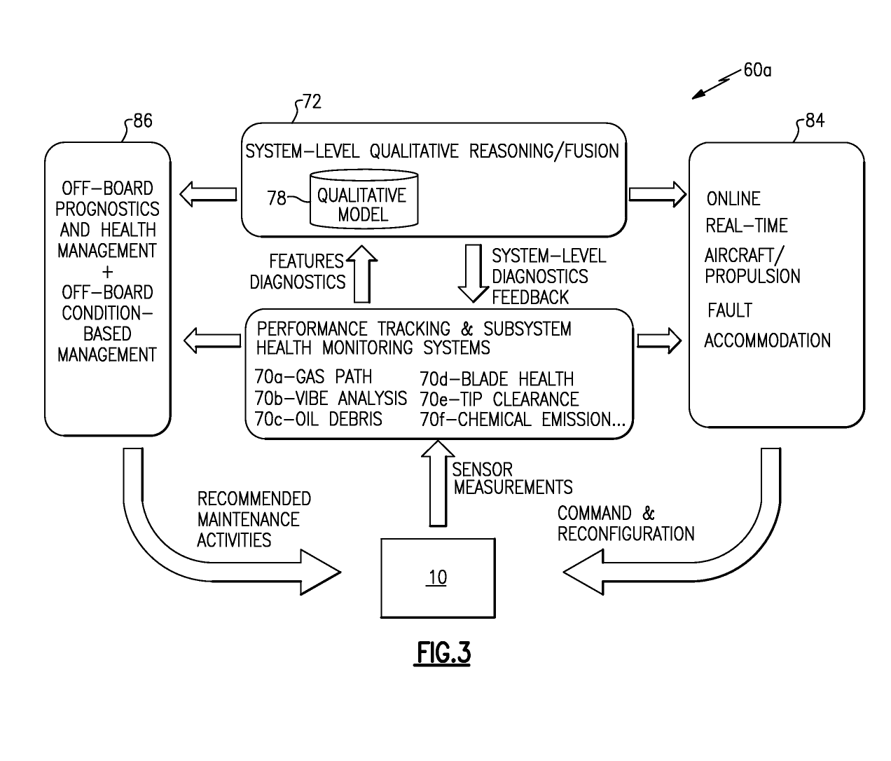

Referring now to FIG. 3 with continuing reference to FIG. 2, the example health management system 60a makes use of at least two models at two different levels of abstraction. One model 78 is a qualitative, relatively high-level model of the engine system 20. This model 78 may be considered a qualitative reasoner, system level aggregator, or system-level reasoner. Some or all of the modules 70a-70n may include quantitative models.

The qualitative model 78, in some examples, provides feedback to one or more of the lower-level diagnostic modules 70a-70n. The feedback may improve the accuracy of diagnoses by the diagnostic modules 70a-70n.

The feedback provided to the diagnostic module 70a-70n, may be based, at least in part, on information collected through sensors 68a-68n in communication with at least some of the other diagnostic modules 70a-70n.

The feedback may change how the diagnostic module 70a-70n treats information communicated from one of the sensors 68a-68n. For example, the sensor 68a may be providing the diagnostic module 70a with inaccurate information. The diagnostic module 70a only recognizes that the information is inaccurate because the diagnostic module 70a has received feedback indicating such from the system level reasoner 72. The diagnostic module 70a is then able to adjust for the inaccurate information. An example of the adjusting includes changing how the component 64a-64n collect information. The diagnostic module 70a may, for example, use information from a sensor 68d-68n not previously associated with the diagnostic module 70a.

The system 60a may provide inputs to online, real-time propulsions fault accommodation, which is represented by block 84 in FIG. 3. The system 60 may also provide inputs to off-board Prognostics and Health Management (PHM) system and Condition-based Maintenance (CBM) system, which is represented by block 86 in FIG. 3.

Other examples of variables monitored by the subsystems include gas path, tip clearances, chemical emissions, oil debris, etc.

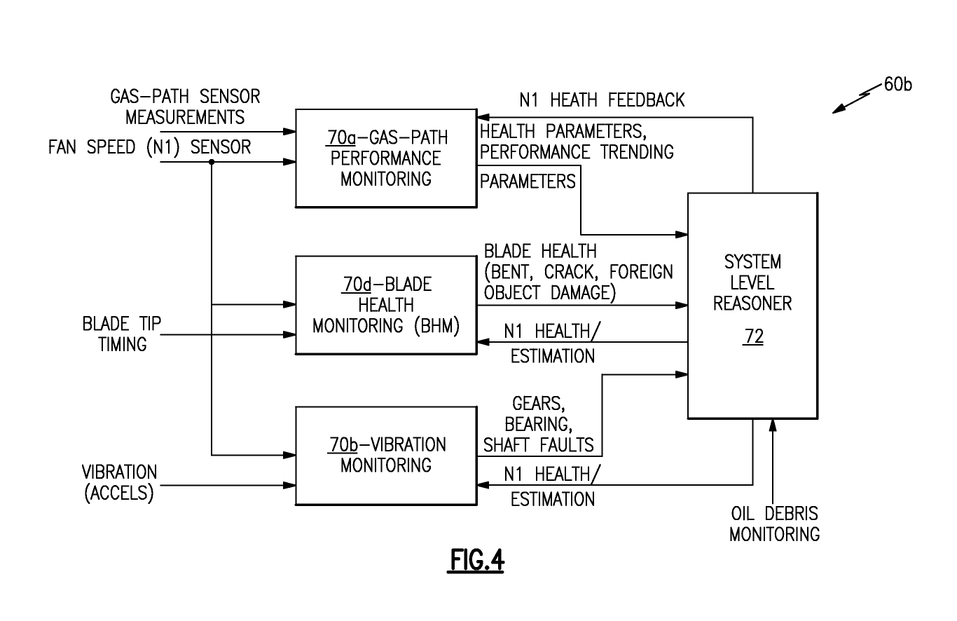

Referring to FIG. 4, an example method 60b shows the flow of how the example techniques of this disclosure may be used in connection with subsystems that monitor gas path performance monitoring 70a, blade health 70d, and vibration 70b. The system level reasoner 72 may utilize the fusion of information passed through these subsystems to provide diagnostic feedback to of each subsystems.

The monitored components may be components 64b, which may be fan blade components, and the sensors 68c-68e associated with monitoring the health of the blade components. One of the sensors 68c measures fan speed. If the diagnostic module 70d determines that the sensor measuring fan speed has failed, the lower-level diagnostic module 70d estimates the correct fan speed using blade tip timing sensors and informs the qualitative model 78 of this failure. The model 78 then fuses the diagnostic information from all subsystems 70a-70n to diagnose the fan speed sensor fault and communicates estimated fan speed to all the subsystems needing this signal. Due to redundant sensor measurements, the module 70d is still able to monitor blade health even though its sensor 68c has failed. The model 78 has thus adjusted how the module 70d collects information.

The substitution of information takes place in subsystem module 70a (which may be a gas path performance monitoring module) rather than within the module 70d. The fan speed sensor information (68c) is substituted by estimated fan speed from module 70d. The model 78 and the diagnostic module 70d have thus adjusted how the module 70a collects information.

Features of the some of the disclosed examples include a system that can adjust the configuration or parameters of subsystem diagnostic modules (which are subject to restricted local information) based on fused results from system level (with global situation awareness) to ensure effectiveness and accuracy. For example, many subsystem diagnostic modules assume sensors are healthy. When a sensor fails, the diagnostic result from this module will no longer be trustworthy. In this case, if the system level reasoner can perform sensor diagnosis based on cross validation with other features, the faulty sensor can be either isolated or replaced by a redundant source to maintain the performance of the affected subsystem diagnostic module.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A method of fusing information within a turbomachine health management system, comprising:
sending information collected within a first subsystem from the first subsystem to a system level reasoner; and
adjusting a different, second subsystem based on the information from the first subsystem.

2. The method of claim 1, wherein adjusting comprises changing how the second subsystem collects information.

3. The method of claim 1, including substituting information sent from the second subsystem to the system level reasoner with information from the first subsystem.

4. The method of claim 1, including recognizing a sensor failure within the second subsystem utilizing information from the first subsystem.

5. The method of claim 1, wherein the adjusting of the second subsystem is based further on information sent from the second subsystem to the system level reasoner.

6. A method of communicating information within a turbomachine health management system, comprising:
collecting information from at least one first subsystem at a system level; and
providing diagnostic feedback to at least one second subsystem, the diagnostic feedback adjusted in response to information from at least one subsystem, the at least one first subsystem different than the at least one second subsystem.

7. The method of claim 6, wherein the first subsystem and the second subsystem collect information from different groups of components.

8. The method of claim 6, including collecting information at the system level using a system-level reasoner.

9. The method of claim 6, including collecting information from the at least one second subsystem at the system level.

10. The method of claim 6, including using the diagnostic feedback to improve the diagnostic accuracy of the at least one second subsystem.

11. The method of claim 6, including adjusting how the at least second subsystem collects information based on the diagnostic feedback.

12. The method of claim 6, including replacing information from the at least one second subsystem with information from the at least one first subsystem based on the diagnostic feedback.

13. The method of claim 6, including recognizing a sensor failure within the at least one second subsystem using the information from the at least one first subsystem.

14. The method of claim 6, wherein the at least one first subsystem and the at least one second subsystem collect at least some information from a turbomachine using a common sensor.

15. A turbomachine health management system, comprising:
a first subsystem module configured to collect information from a first group of sensors within a turbomachine;
a second subsystem module configured to collect information from a second group of sensors within the turbomachine;
a system module configured to adjust the first subsystem module based at least in part on information from the second subsystem module.

16. The turbomachine health management system of claim 15, wherein the first subsystem module is a blade or vane health module.

17. The turbomachine health management system of claim 15, wherein the system module is configured to adjust information received from the first subsystem based on information from the second subsystem.

18. The turbomachine health management system of claim 15, including at least one sensor that communicates information to the first subsystem module.

19. The turbomachine health management system of claim 15, including at least one sensor that communicates information to the first and the second subsystem modules.
